(19) United States
(12) Patent Application Publication
(10) Pub. No.: US 2005/0079024 A1
(43) Pub. Date: Apr. 14, 2005

(54) Chuck device, processing apparatus using the same, and pivot shaft

(75) Inventor: Fumiaki Mitsuhashi, Saitama (JP)

Correspondence Address: SUGHRUE MION, PLLC, 2100 PENNSYLVANIA AVENUE, N.W., SUITE 800, WASHINGTON, DC, 20037, US

(73) Assignee: NSK LTD.

(21) Appl. No.: 10/958,390

(22) Filed: Oct. 6, 2004

(30) Foreign Application Priority Data
Oct. 6, 2003 (JP) P2003-346700

(51) Int. Cl. B23C 1/14

(52) U.S. Cl. 409/165

(57) ABSTRACT

A chuck device for gripping a work having a shaft portion and an eccentric portion with a predetermined eccentricity to the shaft portion. The chuck device includes: a collet chuck for holding one of the shaft portion and the eccentric portion; a chuck driving mechanism for driving the collet chuck to obtain a gripping force for holding the one of the shaft portion and the eccentric portion; a pair of arm portions swingable to be in contact with the other of the shaft portion and the eccentric portion to perform a phase adjustment with respect to the other of the shaft portion and the eccentric portion; an arm driving mechanism for driving the pair of arm portions; and an eccentricity adjustment mechanism configured to adjust a position of the chuck device with respect to a main shaft based on the eccentricity.

### BACKGROUND OF THE INVENTION

1. Field of the Invention

The present invention relates to a chuck device for gripping a work which is provided with an eccentric portion having a predetermined eccentricity with respect to a shaft portion such as a pivot shaft of a toroidal type continuously variable transmission as well as to a processing apparatus for processing the work using the device.

2. Background Art

Methods of processing a work (hereinafter referred to as an eccentric work) such as an automotive component which is provided with an eccentric portion such as an eccentric shaft and an eccentric hole having a predetermined eccentricity with respect to one of shaft portions have heretofore been known (see, for example, JP-A-8-155708). Also, as a chuck device, the one shown in FIG. 4 is known. In the case of processing a pivot shaft 103 of a toroidal type continuously variable transmission provided with an eccentric portion 102 having a predetermined eccentricity with respect to one of shaft portions 101, the chuck device is used for performing positioning (hereinafter referred to as phase adjustment) of a shaft core of the eccentric portion 102 to be processed to the rotation center of a main shaft as shown in FIG. 3.

In the chuck device shown in FIG. 4, a V-shaped bearing 105 is attached to a position which is distant from a rotation center O₁ of a main shaft 104 by a predetermined eccentricity, and the shaft portion 101 of the pivot shaft 103 is in contact with the V-shaped bearing 105. A rockable link member 107 substantially having the shape of the letter L is provided around a pin member 106 of the main shaft 104. A piston member 109 of a hydraulic cylinder mechanism 108 is coupled to the link member 107 at one end thereof, so that a work clamp 110 which is made from a flat plate or the like and disposed at the other end of the link member 107 clamps the shaft portion 101 from above when the hydraulic cylinder mechanism 108 is driven. Accordingly, in this case, the shaft portion 101 is gripped by three flat surfaces of the V-shaped bearing 105 and the work clamp 110 which are in contact with the shaft portion 101.

Since the shaft portion 101 is gripped by the three contacting flat surfaces in the conventional chuck device, the chuck device is relatively low in gripping rigidity and at disadvantage in processing efficiency in cutting or grinding.

Also, the pivot shaft 103 serving as the eccentric work is unbalanced due to its shape, thereby making it difficult to accurately perform the phase adjustment. In actuality, in order to position the core of the eccentric portion 102 to be processed to the rotation center O₁ of the main shaft 104 at the same time with clamping one of the shaft portions 101 to be chucked, it is necessary to rotate the shaft portion 101 in the clamped state. In this case, it is difficult for the chuck device which grips the shaft portion by way of the flat surfaces to generate such rotational force, and a force which pries the chuck can occur. Further, in order to avoid such prying, it is necessary to use a complicated phase adjustment device.

In the case where an amount of runout of a shaft is not equal to or lower than a machining allowance in evaluating the accuracy of the phase adjustment by the runout amount of the shaft, it means that there is a portion left unprocessed. Also, when there is a geometrical tolerance between a portion which is not to be processed and a portion to be processed, it is necessary to further reduce the runout amount so as to satisfy the tolerance even if there is no unprocessed portion. However, as described above, it is difficult to accurately control the runout amount to be equal to or lower than the allowable value.

The present invention has been accomplished in view of the above problems, and an object thereof is to provide a chuck device to be used for processing a work provided with an eccentric portion having a predetermined eccentricity to a shaft portion, which is capable of improving a processing efficiency by gripping the shaft portion with high rigidity and a first run rate of the processing line by accurately performing a phase adjustment as well as of simplifying a replacement of a stage by way of a replacement of a part of jigs and an eccentricity adjustment mechanism, and a processing apparatus using the chuck device.

To achieve the object, the invention provides a chuck device for gripping a work provided with an eccentric portion having a predetermined eccentricity with respect to a shaft portion of the work, the chuck device to be attached to a main shaft, the chuck device including: a collet chuck for holding one of the shaft portion and the eccentric portion; a chuck driving mechanism for driving the collet chuck to obtain a gripping force for holding the one of the shaft portion and the eccentric portion of the work; a pair of arm portions that are swingable to be in contact with the other of the shaft portion and the eccentric portion so as to perform a phase adjustment with respect to the other of the shaft portion and the eccentric portion; an arm driving mechanism for driving the pair of arm portions; and an eccentricity adjustment mechanism configured to adjust a position of the chuck device with respect to the main shaft based on the eccentricity of the eccentric portion to the shaft portion.

Preferably, the gripping force of the collet chuck when the phase adjustment is performed is smaller than a rotation moment generated by the pair of arm portions pressing the work.

Preferably, the collet chuck comprises: an outer diameter collet having a bottom, a cylindrical base coupled to the bottom, a gripping portion projecting from the base in an axial direction and being divided in a circumferential direction to have a circular shape; and a butt for positioning the work in the axial direction.

Preferably, each of the arm portions is provided with a phase adjustment arm; and the arm driving mechanism has a pair of arm reciprocating cylinder mechanisms each moving the phase adjustment arm in the axial direction, an arm swinging cylinder mechanism that functions as a swinging mechanism for swinging the phase adjustment arm, and a rack-and-pinion mechanism.

Preferably, the chuck driving mechanism has an outer diameter gripping cylinder mechanism.

The invention provides a processing apparatus for processing a work provided with an eccentric portion having a predetermined eccentricity with respect to a shaft portion, including: a chuck device for gripping the work, the chuck device attachable to a main shaft; wherein the processing apparatus performs processing on the work with the work being gripped by the chuck device; and the chuck device comprises: a collet chuck for holding one of the shaft portion and the eccentric portion of the work, a chuck driving mechanism for driving the collet chuck to obtain a gripping force for holding the one of the shaft portion and the eccentric portion, a pair of arm portions that are swingable to be in contact with the other of the shaft portion and the eccentric portion so as to perform a phase adjustment with respect to the other of the shaft portion and the eccentric portion, an arm driving mechanism for driving the pair of arm portions, and an eccentricity adjustment mechanism configured to adjust a position of the chuck device with respect to the main shaft based on the eccentricity of the eccentric portion to the shaft portion.

Preferably, the work is a pivot shaft used for a half toroidal continuous variable transmission.

The invention provides a pivot shaft for a half toroidal type continuous variable transmission, including: a shaft portion; and an eccentric portion having a predetermined eccentricity with respect to the shaft portion; wherein the pivot shaft is processed by a processing apparatus having a chuck device for gripping the pivot shaft, the chuck device being attachable to a main shaft, the processing apparatus performing processing on the pivot shaft with the pivot shaft being gripped by the chuck device; and the chuck device comprising: a collet chuck for holding one of the shaft portion and the eccentric portion, a chuck driving mechanism for driving the collet chuck to obtain a gripping force for holding the one of the shaft portion and the eccentric portion, a pair of arm portions for swinging to be in contact with the other of the shaft portion and the eccentric portion so as to perform a phase adjustment with respect to the other of the shaft portion and the eccentric portion, an arm driving mechanism for driving the pair of arm portions, and an eccentricity adjustment mechanism configured to adjust a position of the chuck device with respect to the main shaft based on the eccentricity of the eccentric portion to the shaft portion.

### BRIEF DESCRIPTION OF THE DRAWINGS

The present invention may be more readily described with reference to the accompanying drawings:

FIG. 1 is a top view showing a cylindrical grinding disc provided with a chuck device of this embodiment.

FIG. 2A is a sectional view taken along the line 2A-2A of FIG. 2B and showing the chuck device of this embodiment gripping an eccentric work.

FIG. 2B is a side view of the chuck device of FIG. 2A.

FIG. 3A is a front view showing a pivot shaft of a toroidal,type continuously variable transmission which is an eccentric work of this invention.

FIG. 3B is a side view of the pivot shaft of FIG. 3A.

FIG. 4A is a front view showing a conventional chuck device gripping an eccentric work.

FIG. 4B is a top view showing the conventional chuck device, wherein the eccentric work is held by a V-shaped bearing.

### DETAILED DESCRIPTION OF THE PREFERRED EMBODIMENTS

Hereinafter, one embodiment of the chuck device and the processing apparatus according to this invention will be described in detail with reference to the drawings. Note that an eccentric work W described in this embodiment is a pivot shaft of a toroidal type continuously variable transmission which is provided with a shaft portion and an eccentric portion having a predetermined eccentricity with respect to the shaft portion as has been described under the column of Background of the Invention.

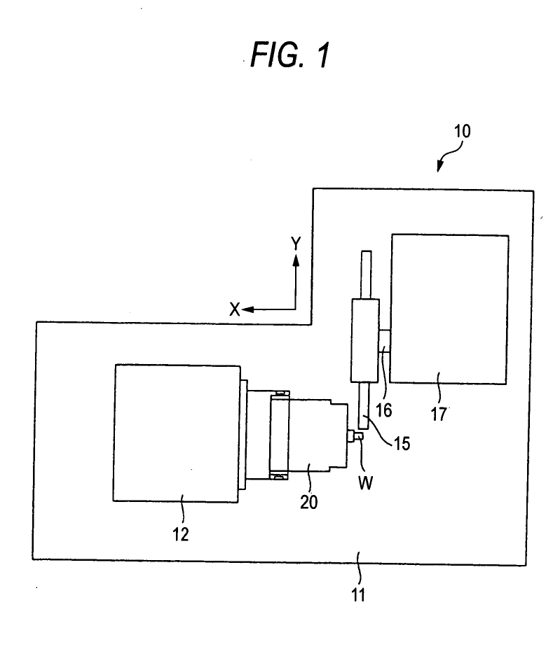

Referring to FIG. 1, a cylindrical grinding disc 10 which is a processing apparatus of this invention has a main shaft 12 provided with a chuck device 20 for gripping the eccentric work W and a wheel spindle stock 17 supporting a wheel spindle 16 to which a grindstone 15 is attached, the main shaft 12 and the wheel spindle stock 17 being arranged on a table 11. The main shaft 12 is movable in an axial direction (direction X in FIG. 1) of the main shaft 12 with respect to the table 11 by way of a movement mechanism (not shown), and the wheel spindle stock 17 is movable in a direction (direction Y in FIG. 1) orthogonal to the direction X with respect to the table 11 by a movement mechanism (not shown).

With the use of such cylindrical grinding disc 10, the main shaft 12 causes the eccentric work W to rotate and move in the X-direction, while the wheel spindle 16 causes the grindstone 15 to rotate and the wheel spindle stock 17 to move in the Y-direction, so that grinding of the eccentric work W is performed.

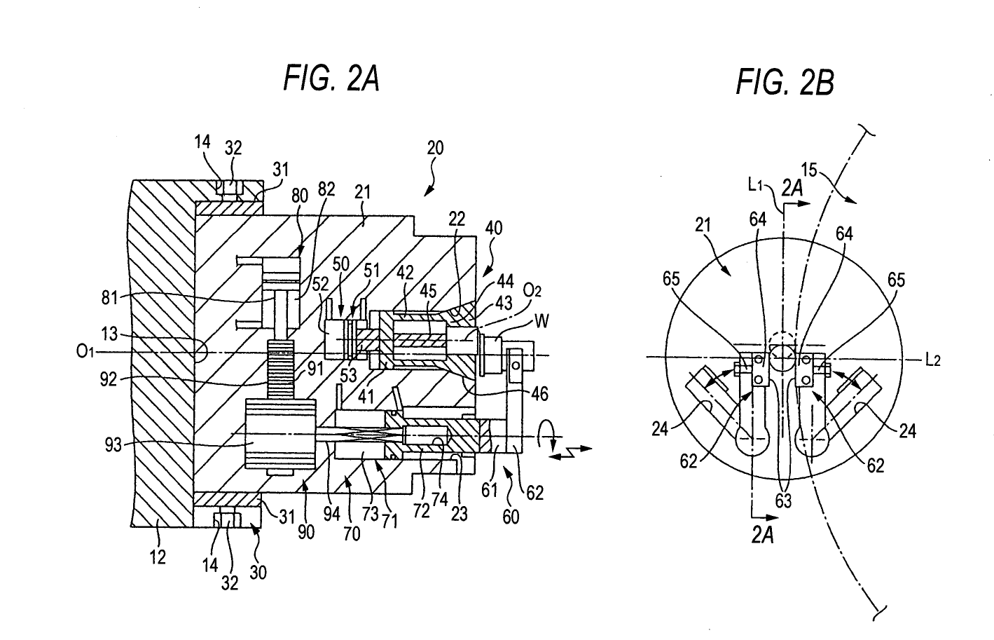

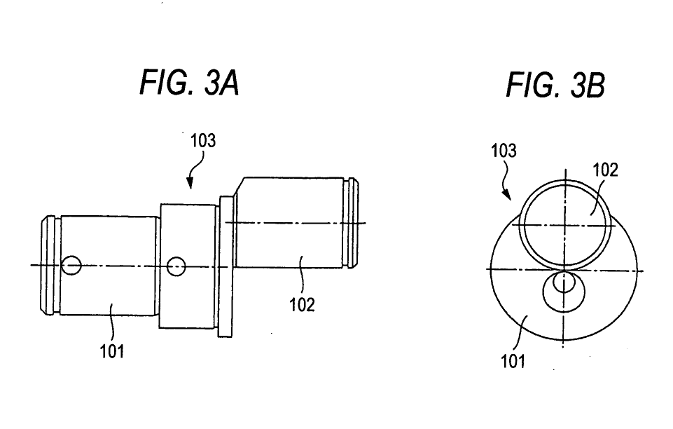

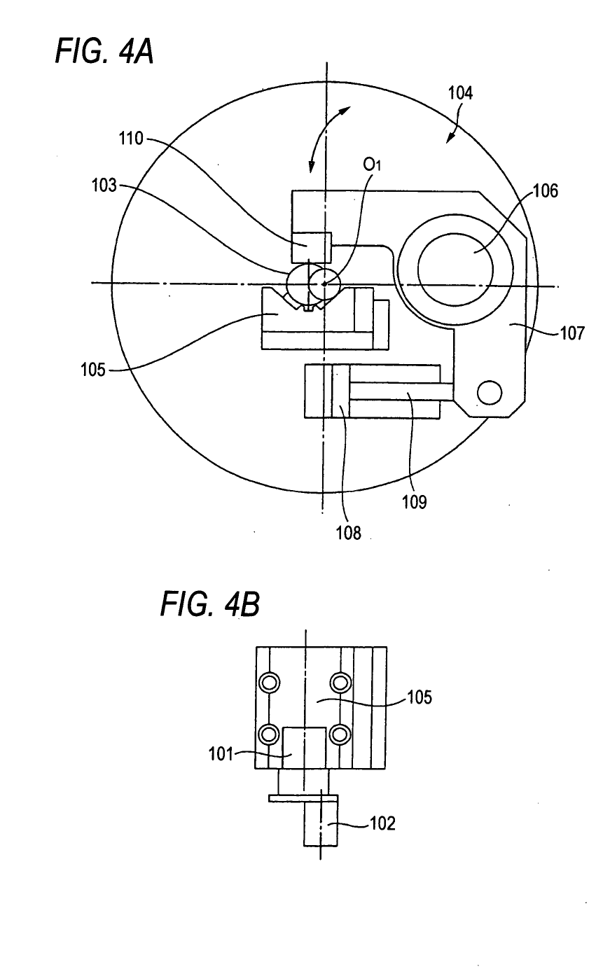

As shown in FIG. 2, the chuck device 20 is attached to the main shaft 12 in such a fashion that a chuck body 21 is abutted on a supporting face 13 and a positioning adjustment is performed in the horizontal direction of FIG. 2, i.e. in an L₁ direction which will be described later in this specification, by way of an eccentricity adjustment mechanism 30. The chuck device 20 has its center O₂ kept at a position distant from the rotation center O₁ of the main shaft 12 by a predetermined eccentricity and is provided with a collet chuck 40 capable of gripping the shaft portion 101 or the eccentric portion 102 (the eccentric portion 102 in this embodiment) and a chuck driving mechanism 50 for driving the collet chuck 40 so as to impart a force to the collet chuck 40 for holding the shaft portion 101 or the eccentric portion 102. Further, the chuck device 20 is provided with a pair of arms 60 capable of so swinging as to contact with the shaft portion 101 or the eccentric portion 102 (the shaft portion 101 in this embodiment) for performing a phase adjustment of the shaft portion 101 or the eccentric portion 102 and an arm driving mechanism 70 for driving the pair of arms 60.

In this embodiment, a line connecting the center O₂ of the collet chuck 40 with the rotation center O₁ of the main shaft 12 is indicated by L₁. A phase adjustment of the chuck device 20 is performed in such a manner that a core of the shaft portion 101 is so positioned as to overlap with the rotation center O₁ of the main shaft 12 with a core of the eccentric portion 102 being overlapped with the center O₂ of the collet chuck 40, i.e. by positioning the cores on the line L₁.

The eccentricity adjustment mechanism 30 has a pair of spacers 31 which are disposed in a direction of the line L₁ on an outer peripheral surface of the chuck device 20, so that a position of the chuck device 20 with respect to the main shaft 12 is adjusted based on the eccentricity of the eccentric work W and in such a manner that the rotation center O₁ of the main shaft 12 overlaps with the core of the shaft portion 101 of the eccentric work W. Also, after the positioning adjustment of the chuck device 20 by the use of the pair of the spacers 31, the eccentricity adjustment mechanism 30 fixes the chuck device 20 to the main shaft 12 by inserting bolts 32 into bolt holes 14 of the main shaft 12. The chuck device 20 is fixed by way of bolts (not shown) along a direction of the rotation center O₁ of the main shaft 12.

In the case of processing various types of eccentric works W which are different in eccentricity, the spacers 31 are exchanged with those different in thickness so that a thickness of one of the spacers 31 is increased and a thickness of the other is reduced by an amount of the increased thickness. More specifically, with the use of various types of spacers 31, it is possible to accurately decide the predetermined eccentricity only by exchanging the spacers 31.

The collet chuck 40 has a cylindrical base 42 coupled to a bottom 41, an outer diameter collet 44 having a gripping member 43 projecting from the base 42 in an axial direction and having a circular shape as being divided along a circumferential direction, and a butt 45 for positioning in the axial direction the eccentric work W which is disposed on the chuck body 21 separately from the collet chuck 40. The outer diameter collet 44 is provided with an outer peripheral surface 46 which is tapered along an inclination of a tapered surface 22 formed on an inner peripheral surface of a hole of the chuck body 21 for housing the collet chuck 40.

The chuck driving mechanism 50 is provided with an outer diameter gripping cylinder mechanism 51 disposed inside the chuck body 21 and a draw bar 53 which constitutes a first piston and is movable in the axial direction with a supply of oil hydraulics to a first cylinder chamber 52. The outer diameter collet 44 is attached to the tip of the draw bar 53, and, when the draw bar 53 is retired, the gripping member 43 is guided along the tapered surface 22 of the chuck body 21 to be elastically deformed, whereby a diameter of the gripping member 43 is reduced. Thus, the collet chuck 40 grips the eccentric portion 102 by the whole outer diameter.

The outer diameter collet 44 is used in accordance with the shape of the eccentric work W to be gripped. Even in the case where the eccentric works W are different in outer diameter, it is unnecessary to replace the outer diameter collet 44 so far as the outer diameter is smaller than an inner diameter of the outer diameter collet 44, and the set of components are usable as it is. The use of the same outer diameter collet 44 is allowed when the difference between the diameters is about 1 mm. In the case where the outer diameter is larger than the inner diameter of the outer diameter collet 44, it is necessary to replace the outer diameter collet 44. Since the outer diameter collet 44 is fitted to the chuck body 21 by way of the taper, the simple replacement is sufficient, and it is unnecessary to perform the centering every time the outer diameter of the eccentric work W changes.

Each of the arms 60 is provided with a swing rod 61 housed in a cylinder 23 of the chuck body 21 as being swingable and movable in the axial direction and a phase adjustment arm 62 capable of being housed in an arm housing 24 formed in an opening of the cylinder 23 and attached to the tip of the swing rod 61, the cylinders 23 being disposed symmetrically about the line L₁. Each of the phase adjustment arms 62 is provided with a contact piece 64 having a contact surface 63 and contacting with the outer periphery of the shaft portion 101 of the eccentric work W from a direction of the line L₂ which intersects the line L₁ and an adjustment bolt 65 for performing fine adjustments of the contact position of the contact piece 64.

The arm driving mechanism 70 is provided with a pair of arm reciprocating cylinder mechanisms 71 which enables axial movements of the pair of phase adjustment arms 62, an arm swinging cylinder mechanism 80 which is a swing mechanism enabling swinging of the pair of phase adjustment arms 62, and a rack-and-pinion mechanism 90 (for example, Mecharotor of ZRB series manufactured by Kondoh Manufacture Corporation).

In each of the arm reciprocating cylinder mechanisms 71, a second piston 72 moves in the axial direction inside a second cylinder chamber 73 with a supply of oil hydraulics, and the phase adjustment arm 62 is moved in the axial direction by way of the swing rod 61 which is connected to the second piston 72.

In the arm swinging cylinder mechanism 80, a third piston 81 reciprocates inside a third cylinder chamber 82 with a supply of oil hydraulics. The rack-and-pinion mechanism 90 is provided with a rack member 92 coupled to the tip of the third piston 81 and having strip tooth rows 91 and a pair of pinion members 93 engaging with the strip tooth rows 91 and rotating in directions reverse to each other. A rotation shaft 94 is coupled to a center portion of the pinions 93, and the tip of the rotation shaft 94 is fixed to an engagement hole 74 formed in the second piston 72. Thus, the pair of pinion members 93 is swung by the reciprocation of the third piston 81 provided in the arm swinging cylinder mechanism 80, and the pair of phase adjustment arms 62 is swung by way of the rotation shaft 94 which is coupled to the pinion members 93 to rotate integrally, the second piston 72, and the swing rod 61.

Hereinafter, effects of the chuck device 20 of this embodiment will be described.

As shown in FIG. 2, the draw bar 53 of the outer diameter gripping cylinder mechanism 50 is withdrawn with the eccentric portion 102 of the eccentric work W being inserted into the gripping member 43 of the outer diameter collet 44. By the above movement, the inner diameter of the outer diameter collet 44 is reduced along the tapered surface 22 of the chuck body 21, so that the collet chuck 40 grips the eccentric work W.

With the withdrawal effect of the outer diameter collet 44, the eccentric work W is positioned in the axial direction by way of a positioning stopper (not shown) provided inside or outside the outer diameter collet 44.

In addition, though an amount of the withdrawal of the collet is about 1 mm, a work pressing mechanism may be provided externally in the case where the withdrawal amount is insufficient.

A gripping force of the collet chuck 40 is reduced in advance of a subsequent phase adjustment. More specifically, the gripping force of the chuck driving mechanism 50 is set to a value which is slightly smaller than a rotation moment occurring when the outer diameter of the eccentric work W is pressed by the phase adjustment arm 62. Thus, it is possible to perform the phase adjustment with the eccentric work W being gripped by the outer diameter collet 44.

By supplying oil hydraulics to the arm reciprocating cylinder mechanism 71 with the eccentric work W being gripped by the outer diameter collet 44, the pair of phase adjustment arms 62 housed in the arm housings 24 of the chuck body 21 are moved forward to be positioned outward from the axial direction. Further, by supplying oil hydraulics to the arm swinging cylinder mechanism 80, the pair of phase adjustment arms 62 swings by way of the rack-and-pinion mechanism 90 in such a fashion as to sandwich the eccentric work W.

Since the pair of phase adjustment arms 62 is actuated by one of the rack members 92, the arms 62 operate in synchronization with each other, and the eccentric work W starts to rotate about the eccentric portion 102 when one of the pair of the phase adjustment arms 62 contacts with the eccentric work W and moves until it contacts with the other arm 62. The phase adjustment is completed when both of the phase adjustment arms 62 contact with the eccentric work W because the eccentric work W cannot move in such state.

In the case where fine adjustments are necessary in this state, a position of the contact piece 64 of the phase adjustment arm 62 is changed by way of the adjustment bolt 65.

After the completion of the phase adjustment, the collet chuck 40 grips strongly the eccentric work W. The phase adjustment arms swing in directions reverse to each other to release the contact thereof with the eccentric work W and then retired in the axial direction to be housed in the arm housings 24 of the chuck body 21. Thus, the chuck operation is completed.

The pair of spacers 31 is replaced in order to equalize the predetermined eccentricity of the eccentric work W with the distance between the center O₂ of the collet chuck 40 and the rotation center O₁ of the main shaft 12. Thus, the set eccentricity is reduced in fluctuation, and the fluctuation is regulated in the range of about ±5 μm.

As described in the foregoing, the eccentric work W gripped by the chuck device 20 is rotated by way of the main shaft 12, and the wheel spindle 16 provided with the grindstone 15 is rotated to move the main shaft 12 and the wheel spindle stock 17 in the X-direction and the Y-direction, thereby performing grinding.

According to this embodiment, since the collet chuck 40 shown in FIG. 2 grips the eccentric work W by the whole outer diameter, gripping rigidity is improved largely, and it is possible to enhance processing efficiency. From one experiment, an increase of about 30% in gripping rigidity as compared with the conventional gripping method was confirmed.

Further, since the phase adjustment is performed with the eccentric work W being gripped with the gripping force smaller than the rotation moment of the phase adjustment arm 62 and in such a fashion as to sandwich the work outer diameter using the pair of phase adjustment arms 62 swinging in synchronization with each other, it is possible to improve the eccentric work phase adjustment accuracy to thereby suppress the runout amount. Also, it is possible to reduce inappropriate chuck to reduce the residual black scale and the reworking of phase adjustment, thereby improving a first run rate of the processing line.

Further, the adjustment of eccentricity of the eccentric work W is performed by using the spacers 31, whereby simple adjustment is realized.

Since the collet chuck 40 is used for gripping the eccentric work W, the centering is unnecessary and it is possible to grip a shaft portion having the size larger than the inner diameter of the outer diameter collet 44 only by exchanging the outer diameter collet 44, thereby making it possible to cope with various dimensions of eccentric works W only by the simple replacement of components.

Further, owing to the above-described effects, it is possible to reduce the cost for processing eccentric work W.

Note that this invention is not limited to the above-described embodiment and that it is possible to modify and improve the embodiment as required. Various methods which adopt the embodiment without departing from the gist of claims and achieve the same effect are encompassed by this invention.

Though the cylindrical grinding disc is described as the processing apparatus provided with the chuck device in this embodiment, it is possible to apply this invention to various processing apparatuses such as those used for cutting processing.

Though the rack-and-pinion rotation actuator is used as the swing mechanism of the arm driving mechanism in this embodiment, it is possible to use another mechanism as the rotation actuator so far as the mechanism is capable of performing the necessary operations.

An air cylinder may be used as each of the outer diameter gripping cylinder mechanism, the arm reciprocating cylinder mechanism, and the arm swinging cylinder mechanism.

Though the pivot shaft having the shaft portions at its sides is described as the eccentric work in this embodiment, the eccentric work may be a component which is an eccentric hole whose eccentric portion has a predetermined eccentricity with respect to the shaft portions.

According to this invention, it is possible to achieve the following effects.

(i) It is possible to shorten a cycle time thanks to a gripping method using a collet chuck which achieves a high gripping rigidity, thereby improving a processing efficiency in processing an eccentric work.

(ii) It is possible to improve a phase adjustment accuracy of the eccentric work to suppress a runout amount, to prevent occurrence of inappropriate chuck, to reduce residual black scale, and to reduce rework of phase adjustment.

(iii) It is possible to adjust an eccentricity of the eccentric work easily by the use of spacers.

(iv) It is possible to cope with various dimensions of various eccentric portions by way of a simple replacement of a set of components without centering.

(v) It is possible to reduce a cost of the eccentric work thanks to the above effects.

1. A chuck device for gripping a work provided with an eccentric portion having a predetermined eccentricity with respect to a shaft portion of the work, the chuck device to be attached to a main shaft, the chuck device comprising:
a collet chuck for holding one of the shaft portion and the eccentric portion;
a chuck driving mechanism for driving the collet chuck to obtain a gripping force for holding the one of the shaft portion and the eccentric portion of the work;
a pair of arm portions that are swingable to be in contact with the other of the shaft portion and the eccentric portion so as to perform a phase adjustment with respect to the other of the shaft portion and the eccentric portion;
an arm driving mechanism for driving the pair of arm portions; and
an eccentricity adjustment mechanism configured to adjust a position of the chuck device with respect to the main shaft based on the eccentricity of the eccentric portion to the shaft portion.

2. The chuck device according to claim 1, wherein
the gripping force of the collet chuck when the phase adjustment is performed is smaller than a rotation moment generated by the pair of arm portions pressing the work.

3. The chuck device according to claim 1, wherein
the collet chuck comprises:
an outer diameter collet having a bottom, a cylindrical base coupled to the bottom, a gripping portion projecting from the base in an axial direction and being divided in a circumferential direction to have a circular shape; and
a butt for positioning the work in the axial direction.

4. The chuck device according to claim 1,
wherein each of the arm portions is provided with a phase adjustment arm; and
the arm driving mechanism has a pair of arm reciprocating cylinder mechanisms each moving the phase adjustment arm in the axial direction, an arm swinging cylinder mechanism that functions as a swinging mechanism for swinging the phase adjustment arm, and a rack-and-pinion mechanism.

5. The chuck device according to claim 1,
wherein the chuck driving mechanism has an outer diameter gripping cylinder mechanism.

6. A processing apparatus for processing a work provided with an eccentric portion having a predetermined eccentricity with respect to a shaft portion, comprising:
a chuck device for gripping the work, the chuck device attachable to a main shaft;
wherein the processing apparatus performs processing on the work with the work being gripped by the chuck device; and
the chuck device comprises:
a collet chuck for holding one of the shaft portion and the eccentric portion of the work,
a chuck driving mechanism for driving the collet chuck to obtain a gripping force for holding the one of the shaft portion and the eccentric portion,
a pair of arm portions that are swingable to be in contact with the other of the shaft portion and the eccentric portion so as to perform a phase adjustment with respect to the other of the shaft portion and the eccentric portion,
an arm driving mechanism for driving the pair of arm portions, and
an eccentricity adjustment mechanism configured to adjust a position of the chuck device with respect to the main shaft based on the eccentricity of the eccentric portion to the shaft portion.

7. The processing apparatus according to claim 6,
wherein the work is a pivot shaft used for a half toroidal continuous variable transmission.

8. A pivot shaft for a half toroidal type continuous variable transmission, comprising:
a shaft portion; and
an eccentric portion having a predetermined eccentricity with respect to the shaft portion;
wherein the pivot shaft is processed by a processing apparatus having a chuck device for gripping the pivot shaft, the chuck device being attachable to a main shaft, the processing apparatus performing processing on the pivot shaft with the pivot shaft being gripped by the chuck device; and
the chuck device comprising:
a collet chuck for holding one of the shaft portion and the eccentric portion,
a chuck driving mechanism for driving the collet chuck to obtain a gripping force for holding the one of the shaft portion and the eccentric portion,
a pair of arm portions for swinging to be in contact with the other of the shaft portion and the eccentric portion so as to perform a phase adjustment with respect to the other of the shaft portion and the eccentric portion,
an arm driving mechanism for driving the pair of arm portions, and
an eccentricity adjustment mechanism configured to adjust a position of the chuck device with respect to the main shaft based on the eccentricity of the eccentric portion to the shaft portion.
